(19) United States
(12) Patent Application Publication
(10) Pub. No.: US 2024/0421442 A1
(43) Pub. Date: Dec. 19, 2024

(54) BATTERY MODULE ASSEMBLY AND METHOD OF MOUNTING A CIRCUIT BOARD OF A BATTERY MANAGEMENT SYSTEM IN A BATTERY MODULE ASSEMBLY

(71) Applicant: DEUTZ Aktiengesellschaft, Cologne (DE)

(72) Inventors: Oliver Günther Hoffmann, Grafschaft (DE); Michael Sachser, Wermelskirchen (DE)

(21) Appl. No.: 18/740,818

(22) Filed: Jun. 12, 2024

(30) Foreign Application Priority Data
Jun. 13, 2023 (DE) 102023002392.2

(51) Int. Cl. H01M 50/519; H01M 50/262; H01M 50/524

(52) U.S. Cl. CPC H01M 50/519; H01M 50/262; H01M 50/524

(57) ABSTRACT

Battery module assembly including a first battery module and a second battery module, each having one or more battery cells, a circuit board of a battery monitoring unit, and a retaining element which has a receptacle in which the circuit board is arranged, where the retaining element is arranged between the first battery module and the second battery module.

The present disclosure relates to a battery module assembly with a retaining element for a circuit board of a battery monitoring unit and an assembly method of a circuit board of a battery management system in a battery module assembly.

In battery module assemblies, several battery modules are spatially combined. For this purpose, the battery modules are often arranged in a housing that also accommodates other components such as cable harnesses and battery monitoring electronics.

A motor vehicle battery with four battery modules and integrated cell monitoring is known from WO 2010 040 520 A2. The four battery modules are arranged directly next to each other and a cell monitoring board is arranged above one of the battery modules.

DE 10 2010 014 905 A1 discloses an energy storage cell unit comprising six energy storage cell units arranged next to each other. A CSE circuit board 28 with corresponding control electronics is arranged above the energy storage cell units.

An aspect of the present disclosure is to provide a battery module assembly and an assembly method for a circuit board of a battery management system in a battery module assembly, each of which enables a space-optimized positioning of a circuit board of a battery monitoring unit.

The battery module assembly comprising: a first battery module and a second battery module, each comprising one or more battery cells, a circuit board of a battery monitoring unit; and a retaining element having a receptacle in which the circuit board is arranged, the retaining element being arranged between the first battery module and the second battery module.

In one possible embodiment, the retaining element can be made of a foamed plastic. The foamed plastic can be expanded polypropylene (EPP) in particular. Foamed plastics, and EPP in particular, can be produced with sufficient tolerances and also have a certain elasticity that enables local forming with little effort. This means that the use of foamed plastics makes it easy to mount the retaining element between the battery modules with high positional accuracy over the service life of the battery module assembly. In addition, foamed plastics have a very low density, which means that their use has a significant weight advantage over metal retaining elements, for example. In addition, foamed plastics have a high damping constant, so that the retaining elements made of foamed plastic can dampen vibrations acting on the circuit board.

In another possible embodiment, the retaining element can have a recess as a receptacle into which the circuit board is inserted. In particular, the circuit board can be arranged in the recess in a direction from the first battery module to the second battery module and/or vice versa without any protrusion.

Furthermore, the circuit board can be attached to the retaining element with one or more fastening elements. The fastening element can be an expansion dowel with a resilient expansion section. The expansion section can be arranged in a hole in the retaining element.

In a further possible embodiment, the retaining element can have a first battery module contact surface which is opposite a side wall of the second battery module, and a second battery module contact surface which is opposite a side wall of the first battery module.

The first battery module contact surface and the second battery module contact surface can be arranged in a direction transverse, in particular orthogonal, to the first battery module contact surface and/or the second battery module contact surface, at least in sections overlapping one another. Alternatively or in combination, the first battery module contact surface and the second battery module contact surface can be arranged in a direction transverse, in particular orthogonal, to the side wall of the first battery module and/or the side wall of the second battery module, at least in sections overlapping one another.

In the unmounted state of the retaining element, a distance of the first battery module contact surface from the second battery module contact surface in a direction perpendicular to the first battery module contact surface and/or the second battery module contact surface may be greater than or equal to a distance of the first battery module and the second battery module in the same direction. Alternatively or in combination, in the unmounted state of the retaining element, a distance of the first battery module contact surface from the second battery module contact surface in a direction perpendicular to the side wall of the first battery module and/or the side wall of the second battery module may be greater than or equal to a distance of the first battery module from the second battery module in the same direction. In other words, the distance of the first battery module contact surface from the second battery module contact surface may be oversized or identical to the distance formed between the first battery module and the second battery module

In a further possible embodiment, the retaining element may have a first positioning section comprising a first height positioning surface and a first side positioning surface. The first battery module contact surface, the first height positioning surface and the first side positioning surface can be arranged orthogonally to one another. The retaining element may alternatively or in combination have a second positioning section comprising a second height positioning surface and a second side positioning surface. The second battery module contact surface, the second height positioning surface and the second side positioning surface can be arranged orthogonally to each other. The first height positioning surface and the second height positioning surface can be arranged parallel to each other. The first height positioning surface and the second height positioning surface can, in particular, lie in a common plane.

Furthermore, the retaining element can comprise a base contact surface that is arranged parallel to the first height positioning surface and/or the second height positioning surface. The distance of the base contact surface from the first height positioning surface can be greater than or equal to a height of the second battery module. Alternatively or in combination, a distance of the base contact surface from the second height positioning surface can be greater than or equal to a height of the first battery module.

In a further possible embodiment, the first side positioning surface and the second side positioning surface can be arranged parallel to each other and in opposite directions towards each other. A distance of the first side positioning surface from the second side positioning surface may be greater than or equal to a common width of the first battery module and the second battery module.

In a further possible embodiment, the battery module assembly can comprise a housing with an inner space in which the first battery module, the second battery module and the retaining element are arranged. The retaining element can have an end surface that is arranged in particular parallel to the base contact surface. The end surface can be in direct or indirect contact with a cover of the housing. The distance between the end surface and the base contact surface can be greater than or equal to the height of the inner space. In other words, the retaining element can be inserted into the housing under preload.

In a further possible embodiment, the retaining element can have a retaining section with a free end that extends along a longitudinal axis of the retaining section. The retaining section can have a recess in which an electronic component is arranged. The recess can be designed as a first groove that runs parallel to the longitudinal axis of the retaining section. A second groove can be formed in the retaining section in the circumferential direction around the longitudinal axis of the retaining section, wherein an annular fastening element is arranged in the second groove, which connects the electronic component to the retaining section.

To solve the problem, a mounting method of a circuit board of a battery management system in a battery module assembly is also proposed, comprising the steps of: Mounting a first battery module and a second battery module in a base element of a housing along a longitudinal axis so that a gap is formed between the first battery module and the second battery module; attaching the circuit board to a retaining element; and inserting the retaining element into the gap, wherein the retaining element is moved from a position outside the gap in a radial plane with respect to the longitudinal axis towards the base element.

The assembly method can be applied in particular to a battery module assembly of a previously described embodiment.

In one possible embodiment, the assembly method may comprise the following steps: Connecting a cover of the housing to the base element so that an inner space is formed between the base element and the cover, in which the first battery module, the second battery module and the retaining element are arranged together with the circuit board, with the retaining element being clamped between the base element and the cover at the same time.

In the following, a possible embodiment of a battery module assembly and an assembly method are described with reference to the figure drawings. Here

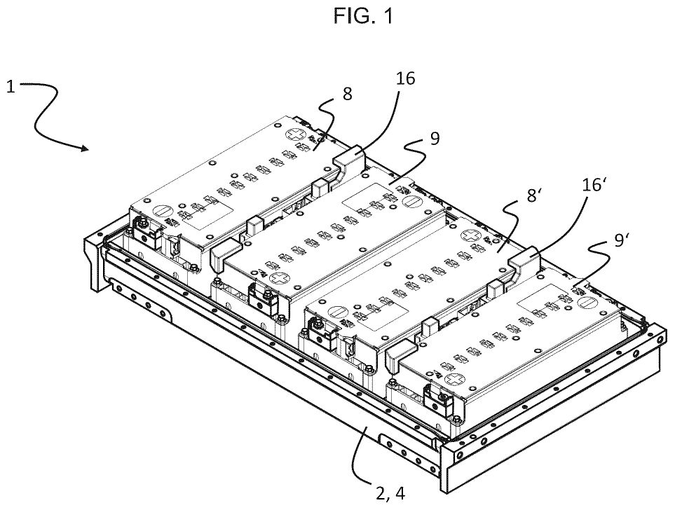

FIG. 1 is a perspective view of a battery module assembly without cover;

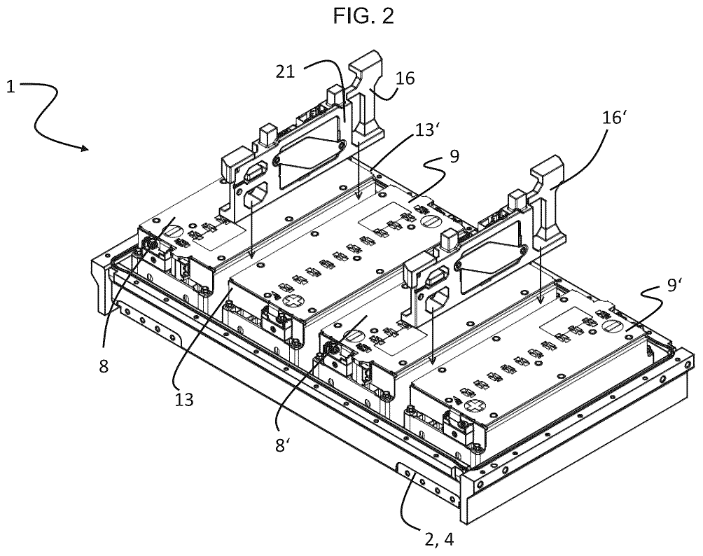

FIG. 2 is the view from FIG. 1 with the retaining elements in a position before assembly;

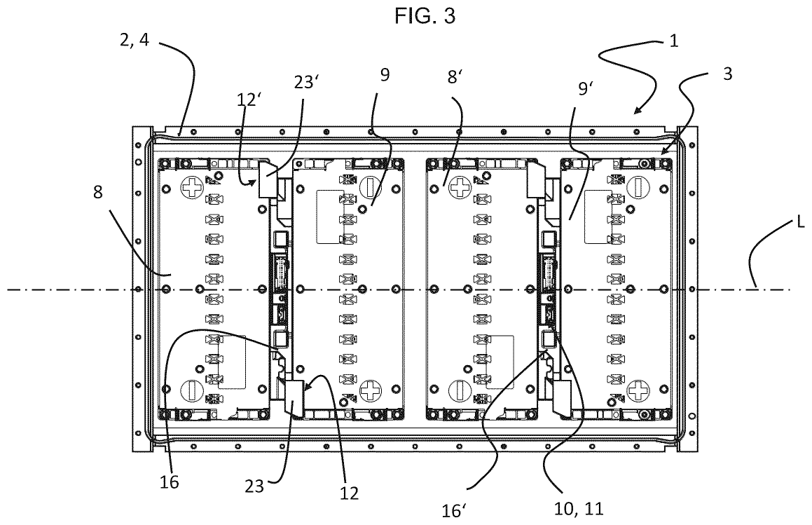

FIG. 3 is a top view of the battery module assembly from FIG. 1 without the cover;

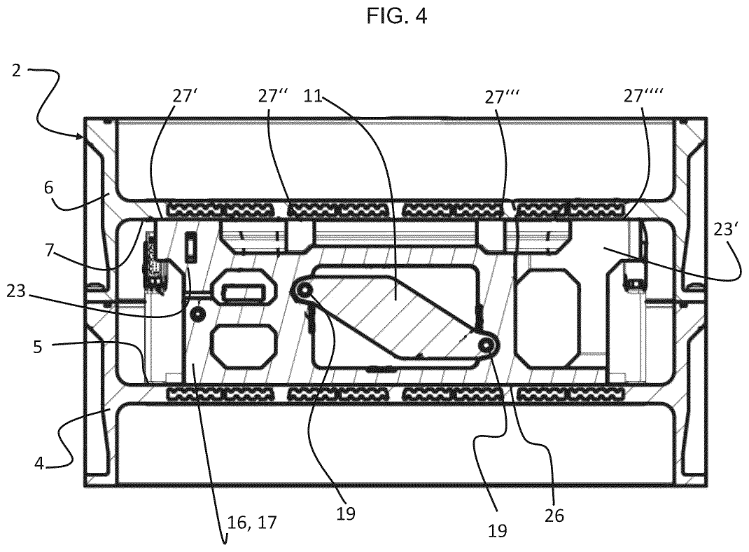

FIG. 4 is a sectional view of the battery module assembly from FIG. 1 with cover, with the sectional plane running through the first retaining element;

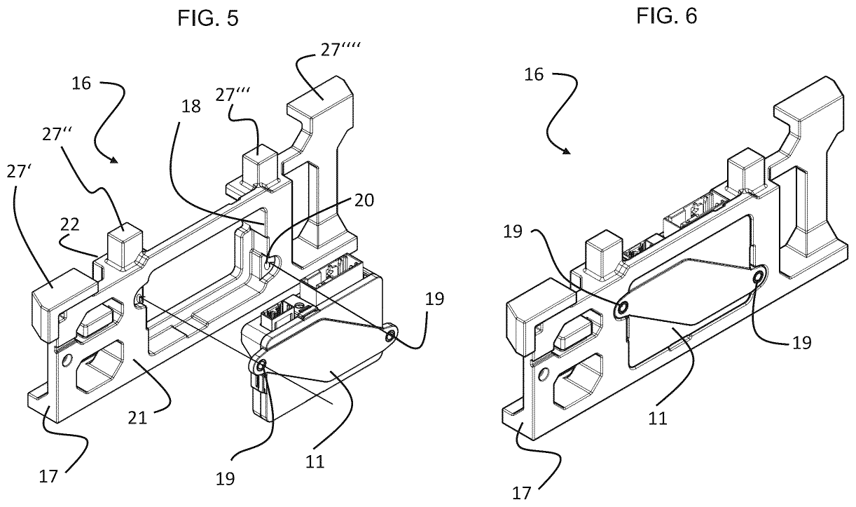

FIG. 5 is a perspective view of the first retaining element from FIG. 1, with the circuit board shown in a position before it is attached to the retaining element;

FIG. 6 is a perspective view of the first retaining element from FIG. 1 with mounted circuit board;

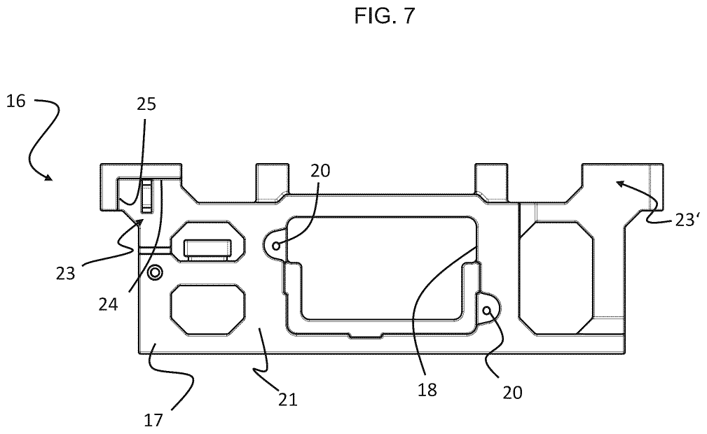

FIG. 7 is a front view of the first retaining element from FIG. 1 without the circuit board;

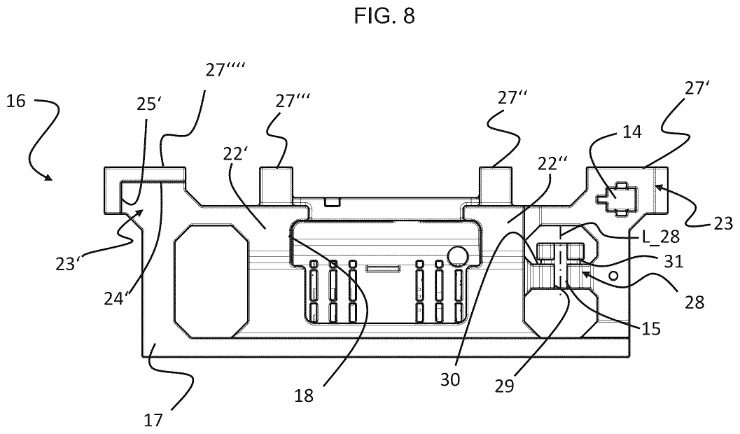

FIG. 8 is a rear view of the first retaining element from FIG. 1 with mounted circuit board;

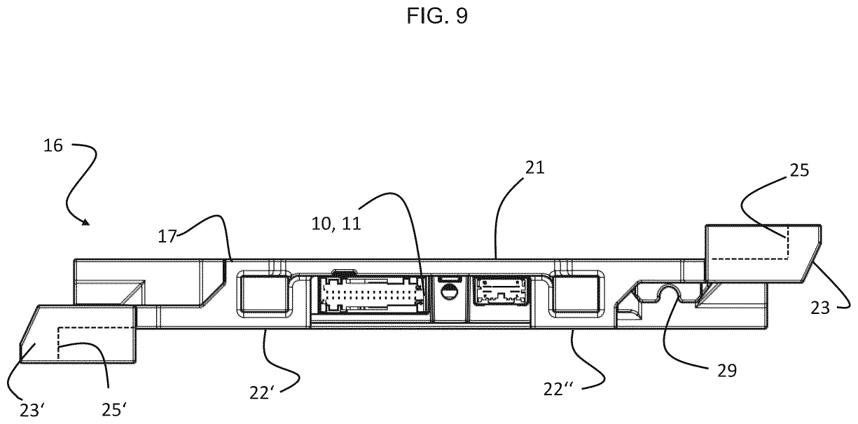

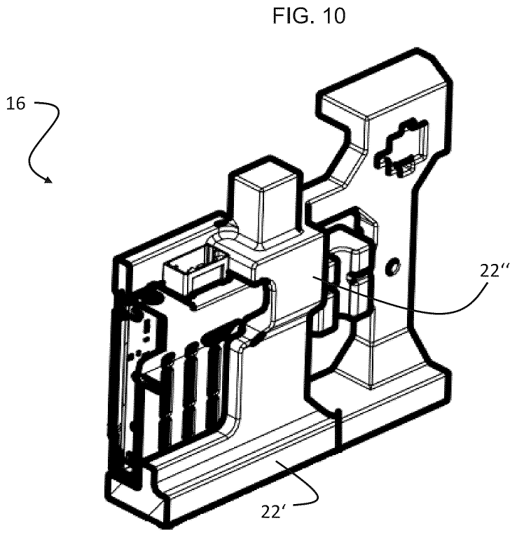

FIG. 9 is a top view of the first retaining element from FIG. 1;

FIG. 10 is a perspective sectional view of the rear side of the first retaining element of FIG. 1; and

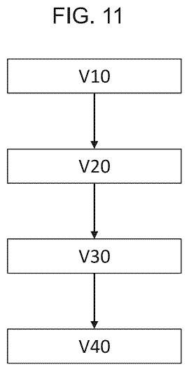

FIG. 11 is a flowchart for an assembly method of a circuit board of a battery management system in a battery module assembly.

FIGS. 1 to 10, which are described together below, show a battery module assembly 1. The battery module assembly 1 comprises a housing 2 with a base element 4 and a cover 6, which together delimit an inner space 3 of the housing 2. Four battery modules are arranged in the housing 2 without being limited to this exact number of battery modules. The battery modules have one or more battery cells and are connected to each other via a high-voltage wire harness not shown.

The battery modules are arranged in two pairs each of a first battery module 8, 8′ and a second battery module 9, 9′. The first battery module 8, 8′ and the second battery module 9, 9′ are each designed identically and arranged rotated by 180° in relation to each other. In particular, it is conceivable that the module arrangement comprises exactly one first battery module 8 and one second battery module 9.

The first battery modules 8, 8′ and second battery modules 9, 9′ are arranged next to each other along a longitudinal axis L of the battery module assembly 1. The first and second battery modules 8, 8′, 9, 9′ are arranged in alternating order. The first and second battery modules 8, 8′, 9, 9′ each have a flat side wall on the sides opposite one of the other battery modules. The side wall is arranged orthogonally to the longitudinal axis L. In other words, the side wall defines a plane that is orthogonal to the longitudinal axis L. A gap is formed between a first battery module 8, 8′ and the adjacent second battery module 9, 9′. A retaining element 16, 16′ is arranged in the respective gap. The first retaining element 16 is arranged between the first battery module 8 and the second battery module 9 and the second retaining element 16′ is arranged between the first battery module 8′ and the second battery module 9′.

The first retaining element 16 and the second retaining element 16′ are identical. The two components are therefore described together below with reference to the first retaining element 16.

As can be seen in particular from FIG. 2, to mount the retaining element 16, it is moved in a plane that is orthogonal to the longitudinal axis L of the battery module assembly 1 in the direction towards the base element 4 of the housing 2 and inserted between the first battery module 8 and the second battery module 9. This assembly movement is illustrated by arrows in FIG. 2. The retaining element 16 is pushed into the gap until a base contact surface 26 of the retaining element 16 is in contact with a base surface 5 of the base element 4. Alternatively, the retaining element 16 is pushed into the gap until the retaining element 16 rests on one of the first battery module and the second battery module.

The retaining element 16 comprises a body 17 made of foamed plastic. In the present case, the body 17 is specifically made of expanded polypropylene (EPP).

The retaining element 16 has a central recess 18 in which a circuit board 11 of a battery management system 10 is arranged. The circuit board 11 is attached to the retaining element 16 with one or more fastening elements 19. In the present case, the fastening element 19 is designed as an expansion dowel that extends into a hole 20 in the retaining element 16.

The circuit board 11 of the first retaining element 16 is connected to the first battery module 8 and the second battery module 9 via a first cable harness. The first wire harness has a connector for the first battery module 8 and a connector for the second battery module 9, with which the cell voltage and the cell temperature of the respective battery module are detected. The circuit board 11 of the first retaining element 16 is connected to the circuit board 11 of the second retaining element 16′ via a second wire harness. The circuit board 11 of the first retaining element 16 and the circuit board 11 of the second retaining element 16′ can communicate with each other and with a central module of the battery monitoring unit via the second wire harness.

The retaining element 16 has a first battery module contact surface 21, which is opposite the second battery module 9. The first battery module contact surface 21 is in contact with the side wall of the second battery module 9. The first battery module contact surface 21 lies in a plane that is orthogonal to the longitudinal axis L. In the present case, the first battery module contact surface 21 is a closed surface that encloses the recess 18. It is also conceivable that the first battery module contact surface 21 is composed of several partial surfaces that are spatially separated from one another and lie in a common plane.

The retaining element 16 has a second battery module contact surface 22, which is opposite the first battery module 8. The second battery module contact surface 22 is in contact with the side wall of the first battery module 8. The second battery module contact surface 22 lies in a plane that is orthogonal to the longitudinal axis L. In the present case, the second battery module contact surface 22 is composed of a first closed partial surface 22′ and a second closed partial surface 22″, each of which lies in the said plane.

The first battery module contact surface 21 and the second battery module contact surface 22 are arranged parallel to each other. The first battery module contact surface 21 and the second battery module contact surface 22 overlap at least in sections in a direction parallel to the longitudinal axis L.

When the retaining element 16 is mounted, the distance between the first battery module contact surface 21 and the second battery module contact surface 22 in a direction parallel to the longitudinal axis L is equal to the distance between the first battery module 8 and the second battery module 9 in the same direction. The retaining element 16 is form-fittingly arranged between the first battery module 8 and the second battery module 9 in a direction parallel to the longitudinal axis L.

In the unmounted state of the retaining element 16, the second battery module contact surface 22 has a first thickening in a direction parallel to the longitudinal axis L in the region of the second partial surfaces 22″. In other words, the thickening is applied to the second partial surface 22″ orthogonally to the plane associated with the second battery module contact surface 22. The thickening of the partial surface 22″ is wedge-shaped in the present case. The amount of thickening of the partial surface 22″ increases with increasing distance from a base contact surface 26 of the retaining element 16.

The circuit board 11 is arranged in the recess 18 in such a way that it is free of protrusions with respect to the plane associated with the first battery module contact surface 21 and the plane associated with the second battery module contact surface 22.

When the retaining element 16 is inserted into the gap between the first battery module 8 and the second battery module 9, the thickening is deformed or compressed in such a way that the area of the thickening subsequently forms a surface in the plane of the second battery module contact surface 22. The retaining element 16 is clamped between the first battery module 8 and the second battery module 9. The retaining element 16 is arranged in a plane that is orthogonal to the longitudinal axis L and is frictionally engaged between the first battery module 8 and the second battery module 9.

It is understood that both the first battery module contact surface 21 and the second battery module contact surface 22 may have one or more of the aforementioned thickenings. In the present case, a second thickening is provided in the area indicated by the reference mark 22′ in FIG. 8.

The retaining element 16 comprises a first positioning section 23 and a second positioning section 23′. The first positioning section 23 comprises a height positioning surface 24. The height positioning surface 24 is arranged parallel to the base contact surface 26. The height positioning surface 24 lies in a plane that is parallel to the longitudinal axis L. The second battery module 9 has a support surface 12 which is in contact with the height positioning surface 24 of the retaining element 16.

In the unmounted state of the retaining element 16, the distance between the height positioning surface 24 of the first positioning section 23 and the base contact surface 26 is greater than or equal to the distance between the support surface 12 of the second battery module 9 and the base surface 5 of the base element 4.

The first positioning section 23 also comprises a side positioning surface 25. The side positioning surface 25 is arranged orthogonally to the height positioning surface 24. The side positioning surface 25 lies in a plane that is parallel to the longitudinal axis L. The second battery module 9 has a side contact surface 13, which is in contact with the side positioning surface 25 of the retaining element 16.

The first positioning section 23 further comprises a section of the first battery module contact surface 21. The height positioning surface 24 and the side positioning surface 25 are each orthogonal to the first battery module contact surface 21.

The second positioning section 23′ comprises a height positioning surface 24′. The height positioning surface 24′ is arranged parallel to the base contact surface 26. The height positioning surface 24′ lies in a plane that is parallel to the longitudinal axis L. The first battery module 8 has a support surface 12′ which is in contact with the height positioning surface 24′ of the retaining element 16. The plane of the height positioning surface 24 of the first positioning section 23 and the plane of the height positioning surface 24′ of the second positioning section 23′ are arranged parallel to one another and, in particular, are identical.

In the unmounted state of the retaining element 16, the distance between the height positioning surface 24′ of the second positioning section 23′ and the base contact surface 26 is greater than or equal to the distance between the support surface 12′ of the first battery module 8 and the base surface 5 of the base element 4.

The second positioning section 23′ also comprises a side positioning surface 25′. The side positioning surface 25′ is arranged orthogonally to the height positioning surface 24′. The side positioning surface 25′ lies in a plane that is parallel to the longitudinal axis L. The first battery module 8 has a side contact surface 13′ which is in contact with the side positioning surface 25 of the retaining element 16.

The side positioning surface 25 of the first positioning section 23 and the side positioning surface 25′ of the second positioning section 23′ are arranged in opposite directions and point towards each other.

In the unmounted state of the retaining element 16, the distance between the side positioning surface 25 of the first positioning section 23 and the side positioning surface 25′ of the second positioning section 23 is greater than or equal to the distance between the side contact surface 13′ of the first battery module 8 and the side contact surface 13 of the second battery module 9.

The second positioning section 23′ further comprises a section of the second battery module contact surface 22. The height positioning surface 24′ and the side positioning surface 25′ are each orthogonal to the second battery module contact surface 22′.

The retaining element 16 has an end surface 27, which is in contact with a cover surface 7 of the cover 6. In the unmounted state of the retaining element 16, the end surface 27 has a distance from the base contact surface 26 which is greater than or equal to a distance between the base surface 5 of the base element 4 and the cover surface 7 of the cover 6 in the assembled state. The relevant cover surface can be formed by the cover 6 itself, as shown in FIG. 4, for example. Alternatively, the cover 6 can comprise one or more additional intermediate elements, which are arranged between the retaining element 16 and the cover element shown in FIG. 4.

In the present case, the end surface 27 is composed of four partial surfaces 27′, 27′″, 27′″, 27″″, each of which lies in a common plane and is in contact with the cover surface 7. The four partial surfaces 27′, 27″, 27′″, 27″″ are distributed across the width of the retaining element 16.

The first partial surface 27′ is formed by the first positioning section 23 and the fourth partial surface 27″″ is formed by the second positioning section 23′. The second partial surface 27″ is formed by a free end of a first beam section of the retaining element 16. The third partial surface 27′″ is formed by a free end of a second beam section of the retaining element 16.

The retaining element 16 is clamped between the base element 4 and the cover 6. For this purpose, after inserting the retaining element 16 into the gap between the first battery module 8 and the second battery module 9, the cover 6 is placed on the base element 4 and clamped together using screw connections. The retaining element 16 between the base element 4 and the cover 6 is slightly compressed. The elasticity of the foamed plastic compensates for any oversizes or undersizes between the retaining element 16, the first battery module 8, the second battery module 9 and the housing 2. The retaining element 16 is thus firmly arranged inside the housing 2 together with the circuit board 11.

The second partial surface 27″ and the first thickening lie in a common first clamping plane, which is arranged orthogonally to the first battery module contact surface 21 and/or the second battery module contact surface 22. The third partial surface 27″ and the second thickening lie in a common second clamping plane, which is arranged orthogonally to the first battery module contact surface 21 and/or the second battery module contact surface 22. The recess 18 respectively the circuit board 11 is arranged at least partially between the first clamping plane and the second clamping plane.

The retaining element 16 further comprises a retaining section 28, which extends along a longitudinal body axis L_28 and has a free end. A first groove 29 is formed in the retaining section 28, which also extends along the longitudinal axis of the body L 28. An electronic component can be arranged in the first groove 29, for example a terminating resistor 15 of one of the wire harnesses mentioned above.

A second groove 30 is formed in the retaining section 28, which surrounds the longitudinal axis of the body L_28 in an annular shape, at least partially. A ring-shaped fastening element 31 is arranged in the second groove 30, which completely encloses the longitudinal axis of the body L_28 and fixes the electronic component 15 in the first groove 29. The fastening element 31 can be designed as a cable tie, for example.

The retaining element 16 also comprises a fastening device 14, with which elements of the above-mentioned wire harnesses can be fastened to the retaining element 16. The fastening device 14 can take the form of a lamellar clip with anti-rotation protection, which is inserted into a hole in the retaining element 16. The lamellae of the clip can reach through the hole and cling to the retaining element 16 with undercuts.

Cooling channels for cooling the battery module assembly 1 are integrated in the base element 4 and/or the cover 6.

FIG. 11 shows an assembly method for a circuit board of a battery management system in a battery module assembly using a flow chart.

In a first process step V10, a first battery module 8 and a second battery module 9 are mounted in a base element 4 of a housing 2 along a longitudinal axis L, so that a gap is formed between the first battery module 8 and the second battery module 9. The battery modules 8, 9 are fixed to the base element 4 in particular.

In process step V20, the circuit board 11 is attached to a retaining element 16.

In a further process step V30, the retaining element 16 is pushed into the gap, whereby the retaining element 16 is moved from a position outside the gap in a radial plane in the direction of the base element. In particular, when the retaining element 16 is inserted into the gap, the retaining element 16 is clamped simultaneously with the first battery module 8 and the second battery module 9.

The retaining element 16 can be pushed into the gap until the retaining element 16 comes into contact with a base contact surface 26 with the base surface 5 of the base element 4. Alternatively, the retaining element 16 can be pushed into the gap until the retaining element 16 comes into contact with a height positioning surface 24 with a support surface 12 of the first or second battery module 8, 9.

In a further process step V40, a cover 6 of the housing is connected to the base element 4. An inner space 2 is formed between the cover 6 and the base element 4, in which the first battery module 8, the second battery module 9 and the retaining element 16 are arranged together with the circuit board 11. In particular, during process step V40, the retaining element 16 is clamped between the base element 4 and the cover 6.

1. A battery module assembly comprising:
a first battery module and a second battery module, each comprising one or more battery cells,
a circuit board of a battery monitoring unit; and
a retaining element, which has a receptacle in which the circuit board is arranged,
wherein the retaining element is arranged between the first battery module and the second battery module.

2. The battery module assembly according to claim 1 wherein the retaining element is made of a foamed plastic, comprised of expanded polypropylene (EPP).

3. The battery module assembly according to claim 1 wherein the retaining element has a recess as a receptacle, into which the circuit board is inserted, the circuit board being arranged in the recess without any protrusion, in a direction from the first battery module towards the second battery module.

4. The battery module assembly according to claim 1 wherein the circuit board is fastened to the retaining element by means of a fastening element.

5. The battery module assembly according to claim 4 wherein the fastening element is an expansion dowel which has a resilient expansion section, wherein the expansion section is arranged in a bore of the retaining element.

6. The battery module assembly according to claim 1 wherein the retaining element has a first battery module contact surface which faces the second battery module, wherein the retaining element has a second battery module contact surface which is opposite the first battery module, and
wherein the first battery module contact surface and the second battery module contact surface are arranged in a direction transverse to the first battery module contact surface and/or the second battery module contact surface, at least partially overlapping one another.

7. The battery module assembly according to claim 6 wherein, in the unmounted state of the retaining element, a distance of the first battery module contact surface from the second battery module contact surface in a direction orthogonal to the first battery module contact surface and/or the second battery module contact surface is greater than or equal to a distance of the first battery module from the second battery module in the same direction.

8. The battery module assembly according to claim 6 wherein the retaining element has a first positioning section which comprises a first height positioning surface and a first side positioning surface, the first battery module contact surface, the first height positioning surface and the first side positioning surface being arranged orthogonally to each other and/or wherein the retaining element has a second positioning section which comprises a second height positioning surface and a second side positioning surface, the second battery module contact surface, the second height positioning surface and the second side positioning surface being arranged orthogonally to one another.

9. The battery module assembly according to claim 8 wherein the first height positioning surface and the second height positioning surface are arranged parallel to one another and lie in a common plane, wherein the retaining element comprises a base contact surface which is arranged parallel to the first height positioning surface and the second height positioning surface, and wherein a distance of the base contact surface from the first height positioning surface is greater than or equal to a height of the second battery module and/or a distance of the base contact surface from the second height positioning surface is greater than or equal to a height of the first battery module.

10. The battery module assembly according to claim 8, wherein the first side positioning surface and the second side positioning surface are arranged parallel to one another and are each orientated towards one another in opposite directions, and wherein a distance of the first side positioning surface from the second side positioning surface is greater than or equal to a common width of the first battery module and the second battery module.

11. The battery module assembly according to claim 9 wherein the battery module assembly comprises a housing with an inner space in which the first battery module, the second battery module and the retaining element are arranged, and that the retaining element has an end surface which is arranged parallel to the base contact surface, wherein a distance of the end surface from the base contact surface is greater than or equal to a height of the inner space.

12. The battery module assembly according to claim 1 wherein the retaining element has a retaining section with a free end which extends along a longitudinal axis (L_28) of the retaining section, and wherein the retaining section has a recess in which an electronic component is arranged.

13. The battery module assembly according to claim 12 wherein the recess is designed as a first groove which runs parallel to the longitudinal axis (L_28) of the retaining portion, wherein a second groove is formed in the retaining section in the circumferential direction around the longitudinal axis (L_28) of the retaining section, and wherein an annular fastening element is arranged in the second groove, which connects the electronic component to the retaining section.

14. A method of mounting a circuit board of a battery management system in a battery module assembly according to claim 1, comprising the steps of:
mounting a first battery module and a second battery module in a base element of a housing along a longitudinal axis, so that a gap is formed between the first battery module and the second battery module;
attaching the circuit board to a retaining element; and
inserting of the retaining element into the gap, wherein the retaining element is moved from a position outside the gap in a radial plane in the direction towards the base element.

15. The method according to claim 14 wherein the method further comprises the step; connecting of a cover of the housing to the base element, so that an inner space is formed between the base element and the cover, in which the first battery module, the second battery module and the retaining element are arranged together with the circuit board, wherein the retaining element is clamped between the base element and the cover at the same time.
